(19) United States
(12) Patent Application Publication
(10) Pub. No.: US 2020/0355161 A1
(43) Pub. Date: Nov. 12, 2020

(54) FLOATING OFFSHORE WIND POWER PLANT HAVING A VERTICAL ROTOR AND MODULAR WIND FARM COMPRISING A PLURALITY OF SUCH WIND POWER PLANTS

(71) Applicants: Charalambos Tassakos, Stuttgart (DE); Athanasios Dafnis, Aachen (DE)

(72) Inventor: Athanasios DAFNIS, Aachen (DE)

(73) Assignees: Charalambos Tassakos, Stuttgart (DE); Athanasios Dafnis, Aachen (DE)

(21) Appl. No.: 16/496,985

(22) PCT Filed: Mar. 23, 2018
(86) PCT No.: PCT/EP2018/057530

§ 371 Date: Jan. 16, 2020

(30) Foreign Application Priority Data
Mar. 24, 2017 (DE) 10 2017 106 434.6

(51) Int. Cl. F03D 13/25; F03D 3/00; F03D 3/06

(52) U.S. Cl. CPC F03D 13/25; F05B 2240/93; F03D 3/061; F03D 3/005

(57) ABSTRACT

An offshore wind turbine floating on a water surface with a rotor with a shaft rotatable about a vertical axis of rotation, the shaft being connected to a generator which converts a rotational movement of the shaft into electrical energy, and with at least one floating body.

The present invention concerns an offshore wind turbine floating on a water surface with a rotor with a shaft rotatable about a vertical axis of rotation. The shaft is connected to a generator which converts a rotary motion of the shaft into electrical energy. In addition, the wind turbine has a floating body that provides buoyancy so that the wind turbine can float on the water surface. The invention also concerns an offshore wind farm that includes several such offshore wind turbines.

There is an increasing worldwide trend towards offshore wind power generation. Compared to onshore wind turbines, these have flow-dynamic advantages and lead to less impact on the environment in settlement areas. Germany is also participating in this development with the construction of the first wind farms off the German coast. The wind turbines planned there correspond to the classic configuration with a horizontal axis of rotation and are installed on so-called foundation structures on the seabed. The classic configuration comprises a relatively high tower, a nacelle at the top of the tower, a drive train with or without gearbox, a generator and control electronics in the nacelle, a rotor with horizontal rotary shaft and rotor blades on the rotor hub flanges as well as wind tracking systems for the nacelle (yaw system) and for the rotor blades (pitch system). The foundation structure is the construction located between the foundation in the seabed and the individual wind turbine, i.e. in the water and water/air boundary. These classic wind turbines use the technological standards of horizontal-axis wind turbines (HAWT), which are also used in onshore operations, to generate energy. The technology used promises a high efficiency of the individual turbine and thus a profitable energy generation at water depths of up to 40 m despite all the associated technical installation problems. From an environmental policy point of view, however, the large-scale anchoring of foundation structures in the seabed is questionable, and from a technical and economic point of view, extending the area into areas of greater sea depths will become complicated and unprofitable.

Wind power generation on floating platforms (so-called barges) can offer an alternative solution that is also more environmentally friendly and more economical. A platform is a support structure with floating bodies, which can support a certain number of optimally positioned wind turbines. Ideally, a modular design is aimed at, in which one module designates a floating support structure unit that accommodates a single wind turbine. Such a module can be placed in isolation or be part of a variable modular interconnection arrangement of several modules. Power generation from floating modular wind farms can be superior in many ways to that from wind turbines installed on solid foundations. Due to the omission of the foundations, the floating arrangement represents a more environmentally friendly variant of offshore energy generation, can achieve a higher output in relation to a total area through flexible topological optimisation of the individual wind turbines and, in the event of malfunctions or failure of important components of the turbines, can enable higher operational availability through uncomplicated module replacement. Individual modules can easily be brought ashore so that maintenance, repair or upgrading (so-called repowering) can be carried out cost-effectively with onshore application techniques.

The concept of generating wind energy on floating platforms is definitely a new development of complete wind turbines. Compared to onshore wind turbines and current trends in the offshore sector, new strategies for the development of suitable wind energy sites can be presented and new types of wind farms can be built.

Due to the floatability and the modular composition of the platforms, this concept is a more environmentally friendly version than other offshore concepts with foundation structures. In addition, there is a very high recovery/recycling efficiency, with the possibility of a natural and complete dismantling of the entire wind farm at the end of its service life.

Due to the modular, platform-like surface construction for the installation of the aerodynamic converters (wind energy converters), installation, logistics, inner park cabling, maintenance and operation management processes become more cost-effective, less risky and technically/practically easier to implement. In addition, sophisticated replacement and repair concepts enable higher availability than with the current offshore concepts.

The development of wind power generation systems on floating, modularly coupled support structures requires the synergy of different fields of technology. A fundamental factor of this synergy is the interface between maritime technology developments and the development of new types of wind energy converters. It is obvious that a transfer of the standard design, consisting of tower, nacelle with integrated drive train and rotor, to a floating support structure is not easily feasible. A floating construction requires a clear shift of the centre of gravity towards the water surface (better even deeper) and a reduction of the mass in comparison to conventional wind turbines. The challenge lies not only in the development of suitable types of wind energy converters, but also in the development of extremely lightweight rotor blade designs and new drive train concepts.

A vertical axis rotor arrangement (vertical axis wind energy plants, VAWEP) of the aerodynamic converter enables the necessary lowering of heavy assemblies of the drive train. This can make it more difficult for the wind turbine to tip over in strong winds and/or rough seas. Such a VAWEP is known e.g. from the US 2016/0327027 A1, where e.g. the generator is arranged at the lower end of the rotor on a floating body of the plant. However, it is problematic that a separate housing must be provided for the generator in order to protect it from moisture, salt, corrosion and mechanical influences. Furthermore, the floating stability of the well-known VWEA is not yet optimal.

On the basis of statistical analyses, from today's point of view the achievable efficiency is less important for the design of wind turbines than the total, actual electricity generation costs. In this approach, VEWAP promises a whole series of advantages in onshore operation. VEWAP, for example, do not require wind tracking, which reduces the design and construction costs. In areas with a constant, rapidly changing wind direction, this tracking is not possible due to the inertia of the nacelle, the rotor blades, the measuring chains and the adjustment devices, so that the rotor of a HAWT is temporarily not optimally flowed against.

Heavy and maintenance-intensive components from the drive train such as gearboxes, generators and suspension bearings can be installed near the ground in a VWEA. Gravity also acts as a constant load on all rotor blades in the VEWAP. In contrast, the rotor blades of a HAWT are cyclically loaded by gravity and are thus exposed to extreme alternating loads, depending on the span.

However, the comparison of the explanations given in the various literature sources makes it clear that no intensive and systematic research has yet been carried out for the VEWAP. This is particularly true for large-scale plants in the MW range, so that there are still many technological development reserves available.

Based on the described state of the art, the present invention is based on the task of designing and further embodiment an offshore wind turbine with a rotor with a vertical axis of rotation for energy generation in the MW range, in such a way that its use in the offshore area is optimized, especially with regard to higher availability and improved efficiency (total costs for production, erection and operation of the wind turbine in relation to the amount of energy generated).

In order to solve this problem, it is proposed that the generator be located in the floating body and accessible from above the water surface via a service flap in the float, starting from the wind turbine of the type mentioned above.

In the sense of this invention, ‘offshore’ does not only mean the open sea. Rather, in the context of the invention, this term should also include larger inland waters, in particular inland lakes (e.g. Caspian Sea, Lake Constance), on which the floating wind turbine or a wind farm composed of several wind turbines could be erected.

According to the present invention, the generator is not simply arranged on the floating support structure, but deliberately arranged in a closed floating body of the turbine, so that no additional housing for the generator (and possibly other mechanical and/or electrical components, such as a gearbox or a frequency converter) is required. The space available in the floating body also allows the design and use of generators of any size. This is unproblematic in so far as a larger floating body to accommodate larger and heavier generators provides more passive float stability of the wind turbine against tipping over. This is due to the fact that the point of attack for the weight force can be easily positioned below the point of attack for the buoyancy force, thus creating a stable state of equilibrium.

To improve the availability of the wind turbine, the floating body has a service hatch that allows service technicians access to the generator for maintenance or repair when needed. Preferably, the service hatch is large enough for the service technician to climb into the floating body to service or repair the generator on site, or to replace commercially available defective standard components. The service technician reaches the floating body at short notice by means of a service ship or a helicopter. Separate floating modules of the same design can be used both as helicopter landing pads and as service ship docking stations. From there it has direct access to the generator via the service hatch and does not have to go from the floating body to a separate generator housing. Especially with floating wind turbines, any route above deck or on ladders, catwalks can be tedious or even dangerous. In this respect, it is a significant improvement if the service technician has direct access to the generator from the floating body and the service flap provided in it.

Preferably the generator is located at least mostly below the water surface in order to shift the centre of gravity of the wind turbine as far downwards as possible and thus prevent the wind turbine from tipping over due to strong wind and/or rough seas.

In accordance with an advantageous further embodiment of the invention, it is proposed that the generator is designed as a flat ring generator, which is free of snap-in-torque and is directly connected to the rotor shaft and directly generates energy of a required grid frequency without the interposition of a frequency converter. By adjusting the inclination of the rotor blades and/or specifically braking the rotor, the speed of the rotor can be kept constant over a wide range independent of the wind speed and/or direction, so that energy can be generated directly at a constant frequency, preferably the desired mains frequency (e.g. traction current 16.7 Hz, 25 Hz in North America, 50 Hz in Europe). Such flat ring generators can have a diameter of >10 m (so-called large ring generators). In particular, large ring generators can have diameters of 10 to 25 m. By means of adequate inverter linkage, they enable interference-free direct generation (i.e. without frequency inverters) of the required mains frequencies even at a limited number of revolutions.

A flat ring generator also has the advantage that the rotor rotates around a vertical axis of rotation during operation, actively stabilizing the wind turbine due to gyroscopic forces and additionally securing it against overturning (so-called gyroscopic effect). A gyroscopic effect is the self-controlling effect caused by gyroscopic forces which is inherent in a system (here: the wind turbine) due to the rotary motion of individual elements (here: a rotating part of the generator). This is not only a float stabilization due to the moment of inertia, but also dynamic processes in connection with the conservation of angular momentum, which can return the system to a stable state even in case of disturbances (here: inclination due to wind and/or swell). Due to the large diameter of the ring generator and the relatively heavy rotating masses, the forces acting on it are also relatively large, resulting in a particularly high floating stability of the wind turbine.

The large fixed and movable masses at the foot of the wind turbine serve on the one hand to improve the passive floating stability due to the low centre of gravity and on the other hand to improve the moment of inertia of the rotor, so that it continues to rotate at an almost undiminished speed even in gusty wind, even if the wind drops briefly. This design also makes it possible to design the upper part of the wind turbine, in particular the rotor, as a lightweight construction without impairing the synchronisation characteristics in gusty wind conditions. This additionally promotes the stability of the wind turbine without impairing the synchronisation characteristics in gusty wind.

In general, the following effects contribute cumulatively to the buoyancy stability or to the improvement of the buoyancy behaviour of the floating body with integrated large ring generators:

1) Point of application of the weight force below the point of application of the buoyancy force. This ensures a passive maintenance of the state of equilibrium.

2) Large tilting moments of inertia due to the large-area placement of solid and rotating heavy masses within the floating body. This suppresses a “nervous” floating reaction of the floating body due to rough seas and/or gusty wind and

3) Maintenance of the angular momentum by the rotating parts of the wind turbine, basically by the masses of the generator rotor, so that an additional active maintenance of the tilting stability is ensured.

According to an advantageous further embodiment of the invention, it is proposed that the ring generator comprises an energy generating section with a generator stator and a generator rotor as well as a bearing section adapted to realize a magnetic bearing of the shaft at least in one direction parallel to the vertical axis of rotation. The bearing section preferably has a first circular or annular section with magnets of a certain polarity and a second section associated therewith with magnets of the same polarity, so that the two sections repel each other and an air gap is formed between the two sections when viewed in the vertical direction, so that the two sections are supported in the vertical direction without material contact solely by magnetic forces. In a wind turbine, the bearings after the rotor and the gear unit (usually gears) are the next most common cause of failure of the wind turbine. In a rotor with a vertical axis of rotation, the greatest forces act in a vertical direction. Due to the special design of the bearings to absorb the vertical forces as magnetic bearings, the availability of the wind turbine can be significantly improved. The magnets can, for example, be superconducting magnets or controlled electromagnets. The magnetic bearing can be designed as a passive, active or electrodynamic magnetic bearing.

The transverse forces acting in the horizontal direction can be absorbed by conventional mechanical bearings (ball bearings, plain bearings, roller bearings, etc.). This is possible relatively easily, since in wind turbines with a rotor with a vertical axis of rotation, the horizontal forces act largely symmetrically. In a further embodiment of the invention, however, it is also possible that the bearing section is designed to realize a magnetic bearing of the shaft also in a direction transverse to the vertical axis of rotation. Here, too, the magnets can be designed, for example, as superconducting magnets or as regulated electromagnets. The magnetic bearing can be a passive, an active or an electrodynamic magnetic bearing.

In order to reduce or even completely avoid an undesired interaction between the magnetic fields for energy generation and the magnetic fields for bearing, it is suggested that the bearing section of the ring generator is offset and at a distance from the energy generation section on the ring generator. The bearing portion may be formed on the ring generator in the direction of the vertical axis of rotation and/or transverse thereto to the power generating portion. In order to achieve the safest and most reliable bearing possible, it is conceivable that several bearing sections are formed on the ring generator. Furthermore, it is conceivable to prefer at least one conventional mechanical bearing which takes over the bearing function in the event of failure of the magnetic bearing.

Offshore wind turbines can take advantage of the special flow dynamics above the water surface, according to which the wind speeds at a low height above the water surface are significantly higher than at the corresponding height above the mainland of the earth's surface (cf. the different flow boundary layer profiles on land and at sea). At sea, the boundary layer profiles are “fuller”. The reason for this is the different roughness of the surfaces. On the mainland, buildings, special topographies (mountains and valleys) and plants (bushes and trees) provide a relatively high roughness, whereas the water surface on the sea or a lake has significantly less roughness. With offshore wind turbines, the wind prevailing at low altitudes directly above the water surface can thus be used to generate energy, so that the rotor blades of a vertical rotor should already have an effective surface immediately (e.g. a few metres) above the water surface that can be exposed to wind. Furthermore, the wind speeds increase with increasing height from the water surface. Nevertheless, in order to ensure that the force applied to the rotor blades remains largely constant over the span of the rotor blades, it can be advantageous if the effective area in the lower area of the rotor blades is larger than in the upper area. In this sense, it is suggested, according to a preferred design of the invention, that the rotor has several rotor blades, each with an essentially vertical span. Depending on the geometry of the rotor blade and in order to set an optimum or appropriate torque curve around the axis of rotation, they can taper upwards or downwards.

In general, in a rotor blade geometry with a constant profile depth, conically pointed rotor blades converging upwards contribute to the regulation of the torque curve. However, a greater profile depth of the rotor blades is preferred at the lower end of the rotor blades than at the upper end. In this case, tapered rotor blades running downwards are advantageous, because—in addition to an appropriate regulation of the torque curve—the upwardly directed force components of the buoyancy force distribution act against the rotor weight, which leads to a relief of the bearing of the rotor. This makes it possible to use new suspension and bearing concepts with reduced consumption of environmentally harmful lubricants. In particular, environmentally friendly (hydraulic) plain bearings, (magnetic) permanent magnet bearings or (pneumatic) air bearings or a combination of these bearings can be used.

To increase the aerodynamic performance, the rotor blade tips are provided with winglets in the upper area in order to minimize the edge vortex effects induced by the pressure compensation. This makes the lift distribution at the upper blade tip area more “full” with the same profile depth, which means a simultaneous increase in the torque generating wind power components. In addition, weakened edge vortices lead to a less disturbing follow-up movement field of the wind turbine. This would be advantageous for the design of wind farms because the aerodynamic performance of neighbouring wind turbines would be less affected. This would reduce the required distance between adjacent modular wind turbines, thus increasing the occupancy density of the wind farm. The application of vortex generators to the suction surface of the rotor blades, near and along the trailing edge of the blades, prevents premature flow separation at larger angles of attack along the span. This means that the rotating blades remain in an aerodynamically optimal condition for longer.

It is also proposed that the rotor should have several rotor blades, each spaced from the axis of rotation, with the span of each rotor blade having a helical shape around the axis of rotation/rotary shaft. It is particularly preferred if the rotor blades are twisted around the axis of rotation around a part of the circumference of the rotor that corresponds to at least one reciprocal of the total number of rotor blades of the rotor. For example, it is conceivable that when using three rotor blades distributed evenly around the axis of rotation, each rotor blade is twisted by at least ⅓ of its circumference around the axis of rotation, i.e. extends from the lower end to the upper end in a circumferential range of at least 120°.

This results in a possible geometry of the rotor blades:
Darrieus type (rotor with two curved, elastic blades),
VAWIAN type (rotor with two straight, rigid H-shaped blades),
H-Darrieus type (rotor with several straight rigid blades), and
Twisted”, rigid rotor blades (3D strand design in double helix shape or triple helix shape, so-called twister).

For all geometries mentioned above, the rotor blades may have an increasing profile depth along their span due to the atmospheric wind flow boundary layers in order to make optimum use of the wind inflow. From the point of view of a structural-mechanical/ aerodynamic comparison with regard to load-bearing capacity and maximum wind energy generation, the rotor blades in the lower area will have greater profit depths than in the upper area when optimizing the rotor blade geometry (rotor blade surface area, span, aspect ratio, profile depth). A corresponding blade twisting along the span, the insertion of winglets at the upper rotor blade tips and the placement of vortex generators will additionally significantly increase the aerodynamic effect.

A triple helix shape of rotor blades has a demonstrably comparable low-vibration operation, which is a great advantage both mechanically and environmentally (low-noise).

In addition, new structural design concepts can be applied to the wind turbine with vertical axis of rotation, which are currently only used in aircraft construction to produce the rotor blade structure and the torque-transmitting shafts and axes in extremely lightweight construction while maintaining sufficient strength and structural stability. The use of fibre-reinforced composites is aimed at a fibre-compatible production, which enables even lighter designs while complying with the strength and rigidity requirements.

The necessary mass of inertia for maintaining the angular momentum can be accommodated in the floating body (module) (see e.g. permanent magnets for the rotor of the ring generator, in particular with a diameter>10 m, and the bottom bearing of the rotary arrangement).

In addition to the structural mechanical advantages, an extremely lightweight construction of the aerodynamically loaded rotary assembly also has a special effect on material and transport costs, on handling during assembly and exchange activities and on environmental friendliness and recycling efficiency due to the use of less material.

It is conceivable that the wind turbine is anchored to the bottom of the water on which it floats by means of sagging or prestressed lines. With the help of the lines, the wind turbine can be anchored at a specific position above the seabed, even at relatively great depths. The application of the lines is much easier, cheaper and less laborious than the construction of a foundation for floating Wind Energy Turbine's firmly anchored in the seabed. However, it is advantageous if the anchoring concept allows wind tracking of individual or all wind turbines in a wind farm. This can be achieved, for example, by motorised drive modules between the floats of individual wind turbines.

According to another advantageous further embodiment of the present invention, it is proposed that the wind turbine has a Global Navigation Satellite System, hereinafter GNSS, to detect a current position of the wind turbine, a drive to change the position and/or orientation of the wind turbine on the water surface, and a control device associated with the GNSS and the drive to control the drive depending on the detected position of the wind turbine to bring the wind turbine to a desired position and/or orientation on the water surface. In this way it is possible for the wind turbine to automatically move to a desired position and remain there. In addition, the orientation of the wind turbine can be varied by taking into account the wind direction and strength when controlling the drive in order to optimise the energy generation independent of the wind conditions.

The invention also proposes a modular offshore wind farm comprising several inventive offshore wind turbines. Preferably, the individual wind turbines of the wind farm are rigidly connected to each other. Helicopter landing modules or ship mooring modules can be arranged between the floating bodies of individual wind turbines or to the side of them, so that persons (e.g. maintenance and inspection personnel) can be set down on the wind farm. In this case it is advantageous if only at least one selected wind turbine of the wind farm, e.g. a helicopter landing module of the wind farm, a GNSS to be able to detect a current position of the wind farm and at least two motors for propulsion to be able to change the position and/or orientation of the entire wind farm on the water surface within the framework of a wind tracking system, is equipped.

Further features and advantages of this invention are explained below with reference to the figures. It shows:

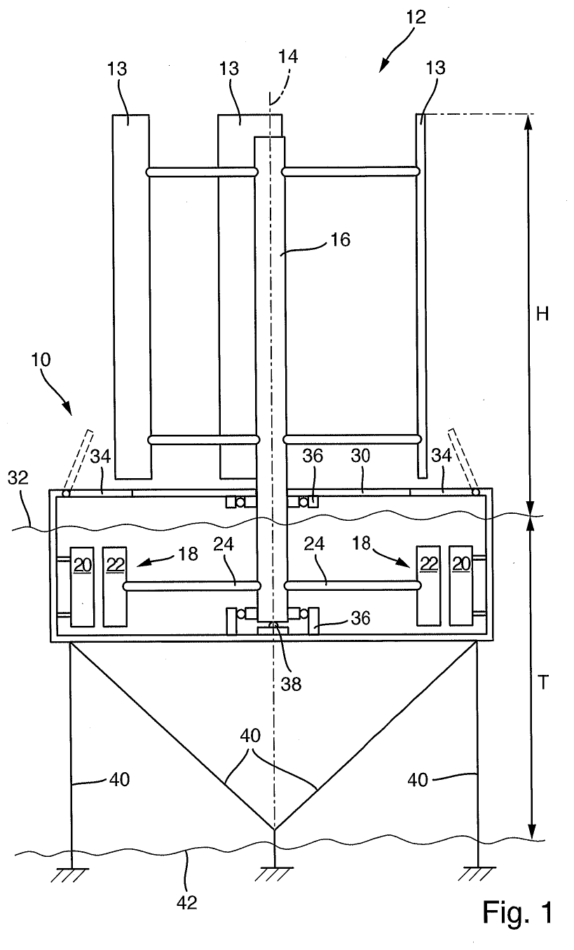

FIG. 1 a wind turbine according to invention according to a first preferred design in a side view partially in section;

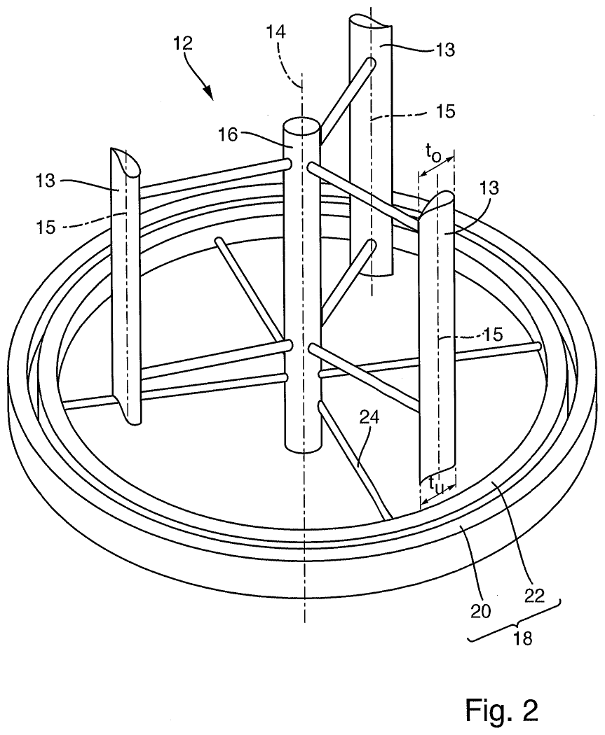

FIG. 2 a perspective view of a part of the wind turbine from FIG. 1;

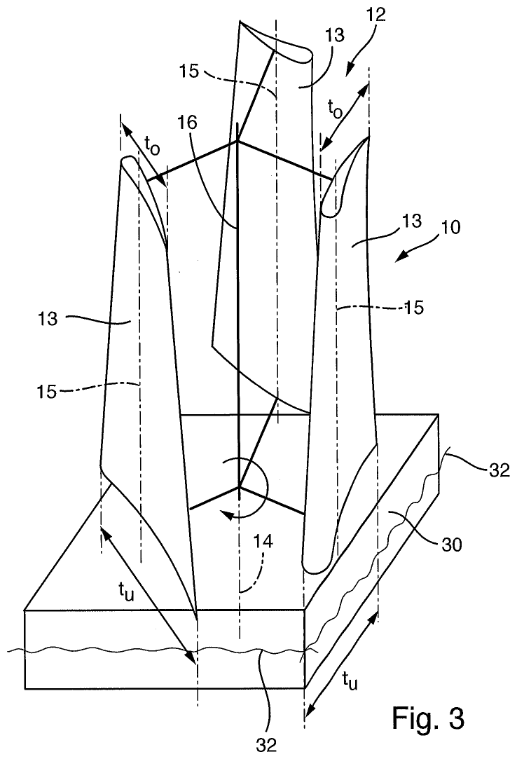

FIG. 3 an inventive wind turbine according to another preferred design in a perspective view;

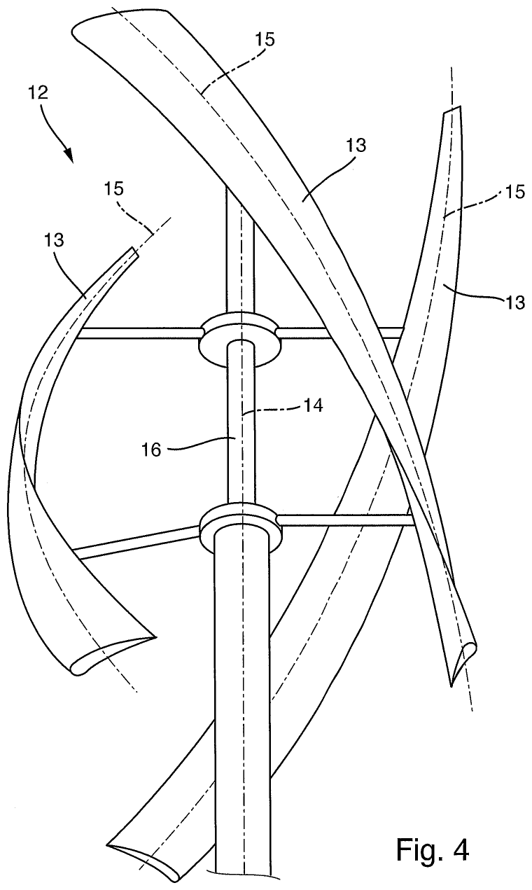

FIG. 4 an example of a rotor of an invented wind turbine in a perspective view;

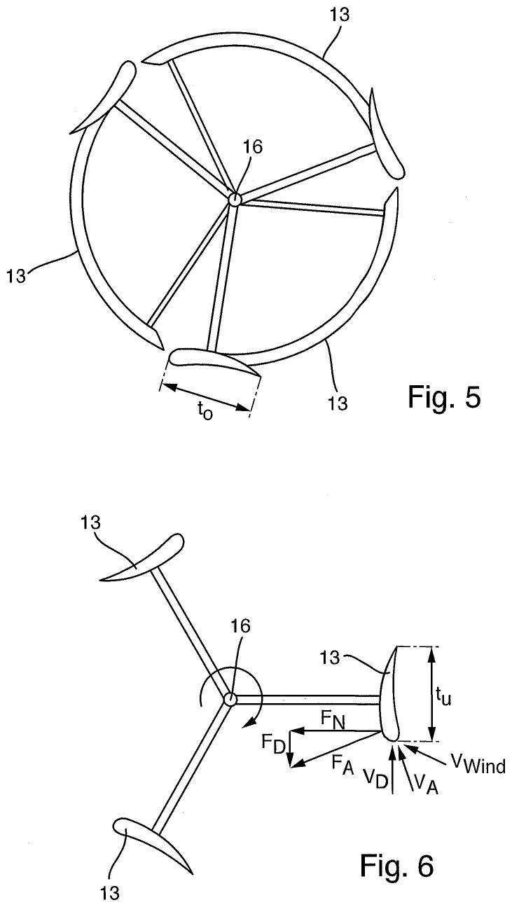

FIG. 5 a horizontal section through an upper end of another example of a rotor of an invented wind turbine;

FIG. 6 a horizontal section through a lower end of the example of a rotor of an inventive wind turbine from FIG. 5;

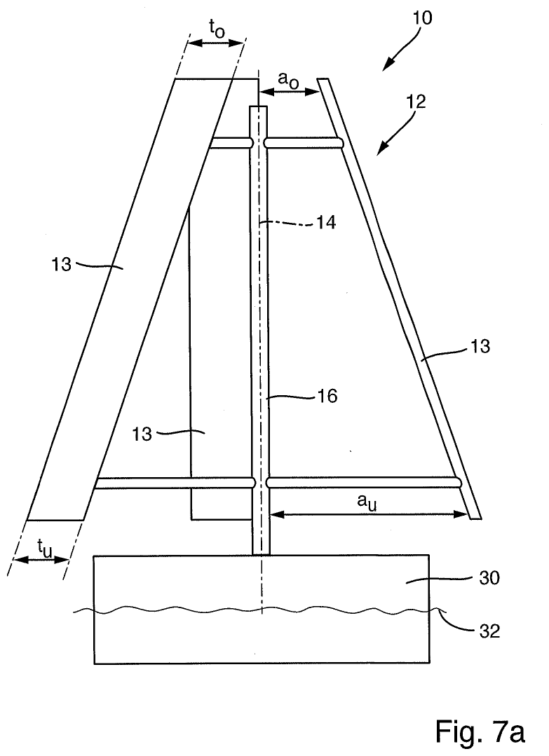

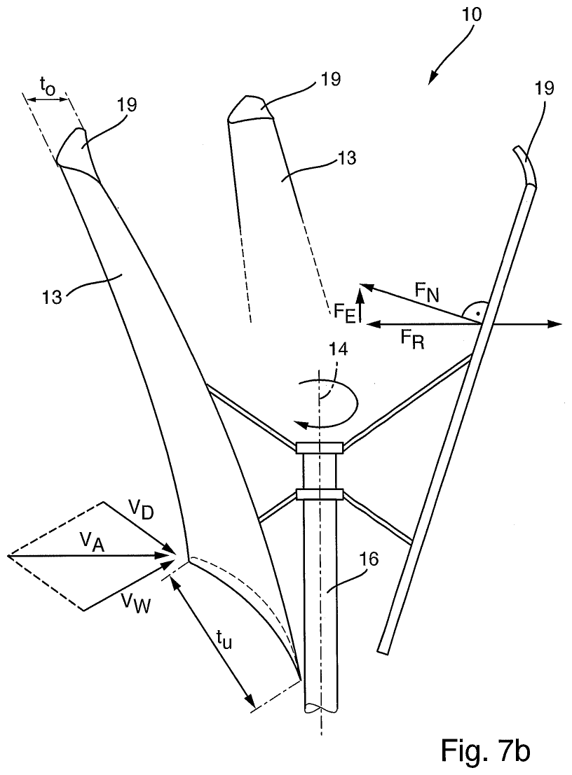

FIG. 7a an invented wind turbine according to another preferred design in a side view;

FIG. 7b an inventive wind turbine according to another preferred design in a side view;

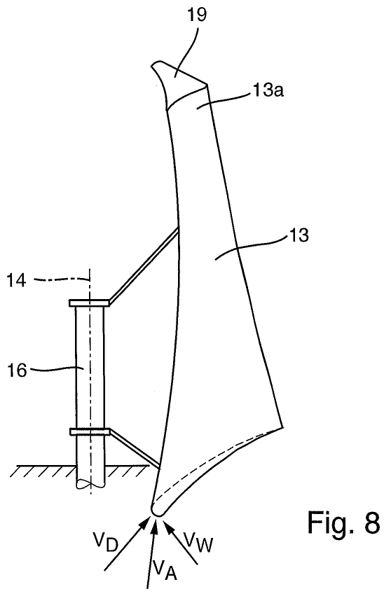

FIG. 8 an exemplary rotor blade of an inventive wind turbine;

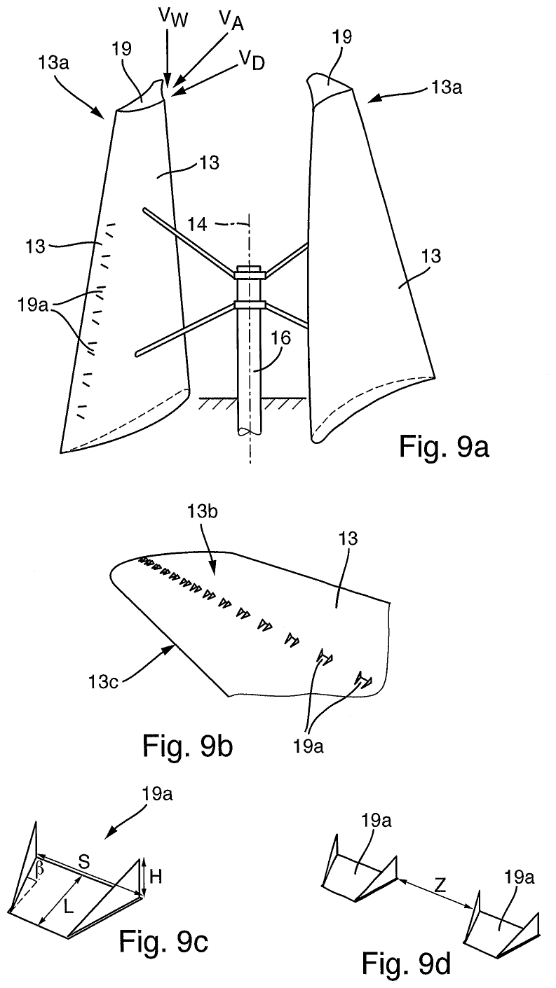

FIG. 9a two exemplary rotor blades of an inventive wind turbine;

FIG. 9b-9d Details of the rotor blades from FIG. 9a;

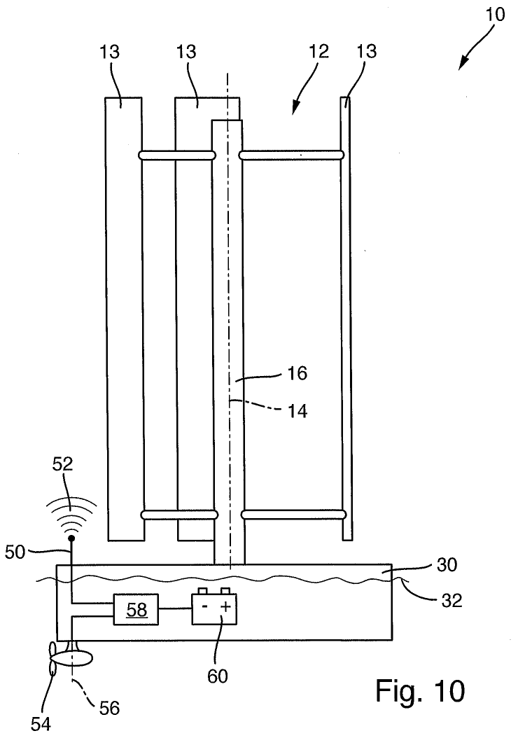

FIG. 10 an inventive wind turbine according to another preferred design in a side view partly in section;

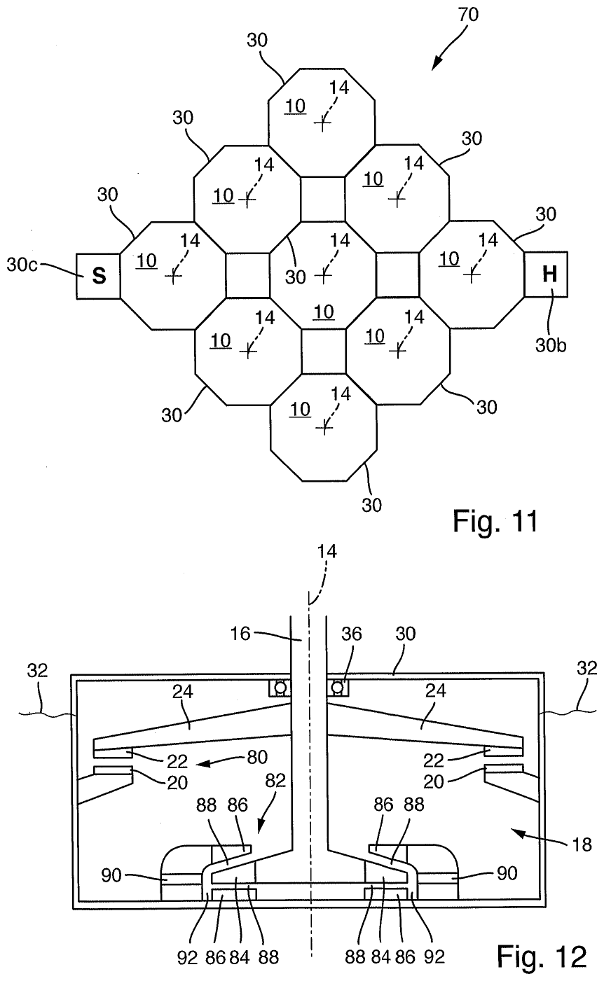

FIG. 11 a top view of a wind farm according to the invention including several wind turbines according to the invention;

FIG. 12 a section of a lower part of a wind turbine according to the invention according to another preferred design;

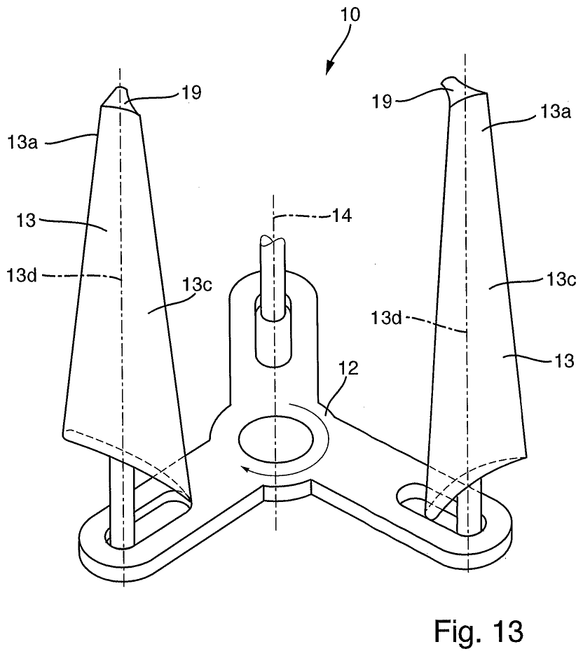

FIG. 13 a section of an inventive wind turbine according to another preferred design in a perspective view;

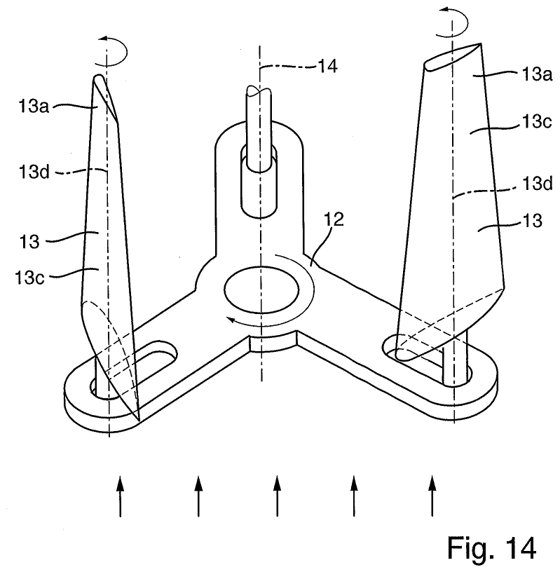

FIG. 14 a section of a wind turbine conforming to the invention according to another preferred design in a perspective view; and

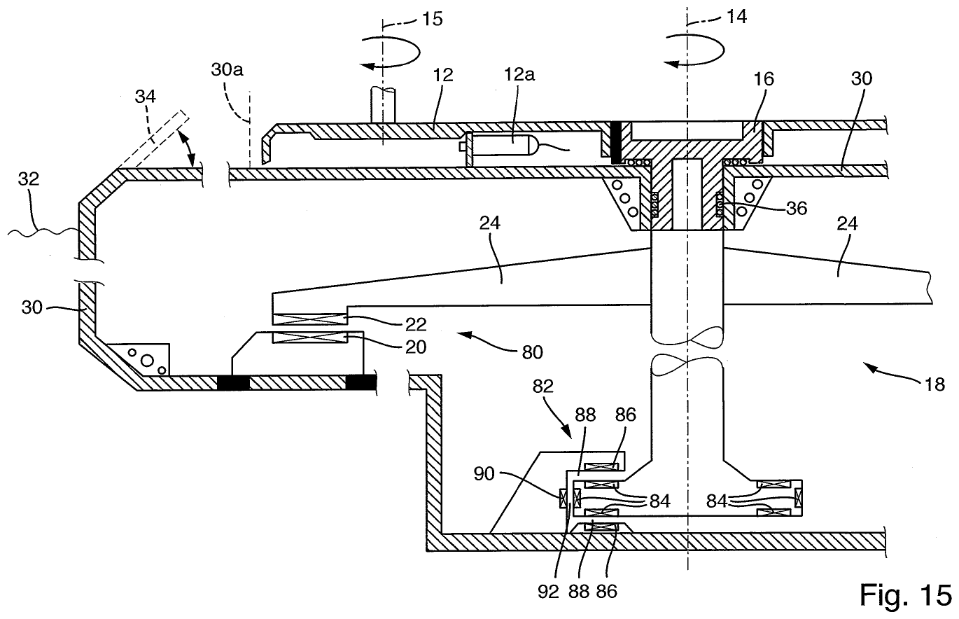

FIG. 15 a section of a lower part of the wind turbine from FIG. 14 according to another preferred design.

In the following, various examples of the design of a wind turbine according to the invention are shown, each of which has different characteristics. Of course, it is also conceivable to combine the features of the individual design examples in any way, even if this is not explicitly shown in the figures or explained in the description. The individual features of the various design examples can therefore be combined with each other in any way.

FIG. 1 shows a side view of a section of a wind turbine according to the invention. The wind turbine is designated in its entirety with the reference sign 10. This is a floating offshore wind turbine with a rotor 12 with a shaft 16 rotating around a vertical axis of rotation 14. The shaft 16 is connected to a generator which is designated in its entirety with the reference sign 18. The generator 18 converts a rotary motion of the shaft 16 into electrical energy. Furthermore, the wind turbine 10 comprises at least one floating body 30.

The floating body 30 provides the necessary buoyancy so that the entire wind turbine 10 can float on a water surface 32.

According to the present invention, the generator 18 is arranged in the floating body 30 preferably below the water surface 32. Furthermore, the generator 18 is accessible from above the water surface 32 via one or more service flaps 34, which are formed in the floating body 30. The opened service flaps 34 are shown in FIG. 1 with dashed lines as examples. When the service flaps 34 are closed, the floating body 30 is watertight so that no water can penetrate into the inside of the floating body 30. In the event that water should nevertheless penetrate (e.g. through a service flap 34 opened for a short time or due to a leak in the floating body 30), a water level sensor (not shown) and/or a bilge pump (not shown) can be arranged inside the floating body 30. Shaft 16 may be supported in floating body 30 by one or more radial bearings 36 and/or by one or more axial bearings 38.

In FIG. 1, the floating body 30 floats on the water surface 32. Of course, it would also be conceivable that the floating body would be arranged completely under water, with the service flap 34 then being arranged at the end of a pipe or snorkel projecting above the water surface through which the interior of the floating body 30 is accessible.

The arrangement of the generator 18 in the floating body 30, preferably below the water surface 32, shifts the centre of gravity of the wind turbine 10 as far down as possible, so that a particularly high passive stability of the wind turbine 10 against tipping over results. In addition, the generator 18 can be reached particularly quickly and easily by service technicians via the service flaps 34, so that maintenance and/or repair of the generator 18 is possible within a particularly short time and the availability of the wind turbine 10 increases.

The generator 18 is preferably designed as a flat-lying large ring generator and is shown in FIG. 1 in cross-section. Of course, other types of generators can also be used. The generator 18 comprises in particular a generator stator 20 and a relatively rotating generator rotor 22. Present large ring generators for on-shore operation have a diameter of approx. 5 m. The generator stator 20 and the generator rotor 22 are mounted on the generator shaft. Recent research has reported significant increases in the performance of ring generators with a diameter of more than 10 metres. Such ring generators 18 can be arranged particularly advantageously in the large floating body 30 of the wind turbine 10, since the floating body 30 must have a certain minimum size anyway in order to achieve a desired minimum floating stability (protection against tipping over) and the floating stability of the wind turbine 10 is the better the larger the floating body 30 is. In addition, large floats are desired for specific circumferences in order to achieve an appropriate minimum distance from adjacent wind turbines in a modular wind farm if adjacent wind turbines are adjacent to each other with their floats. Optimum installation distances of wind turbines within a wind farm are defined on the basis of the flow-induced wake fields of the individual wind turbines (cf. FIG. 9). In addition, due to the gyroscopic effect and the resulting gyroscopic forces, the rotating ring generator 18 or rotating rotor 22 provides additional “active” stability both of the rotor shaft itself (rotational stability) and of the entire wind turbine 10 with regard to its floating behaviour (floating stability). Both the stator 20 and the rotor 22 are ring-shaped in the example shown. The rotor 22 is connected to the shaft 16 via a supporting structure 24. The stator 20 is attached to the wall (alternatively also to the floor) of the floating body 30 by means of another supporting structure 25.

Rotation of the rotor 12 of the wind turbine 10 by applying wind to the rotor blades 13 causes the rotor 22 of the generator 18 to rotate about the axis 14 relative to the stator 20. The rotor 22 of the generator 18 can be supported by means of a magnetic bearing or in some other way. If the rotor has 22 permanent magnets distributed with alternating polarity around the circumference and the stator 20 has several coils, the rotation of the rotor 22 induces a current in the coils. The rotation of the rotor 12 of the wind turbine 10 can be varied by adjusting the angle of attack of the rotor blades 13 and/or by braking the rotor 12 in such a way that energy of a desired constant grid frequency (e.g. 25 Hz or 50 Hz) is always generated between the rotor 12 of the wind turbine 10 and the rotor 22 of the generator 18, independent of the current wind situation and without a gear.

In the example shown, the floating body 30 is anchored to the seabed 42 by means of prestressed or sagging lines 40. This ensures that the wind turbine 10 is always positioned at a given position with respect to the seabed 42 without the need for a foundation in the seabed 42 and a complex and expensive supporting structure for the wind turbine 10. Of course, other measures are also conceivable to keep the wind turbine 10 in a pre-determined position with respect to the seabed 42. The depth T between the water surface 32 and the sea bed 42, in which the wind turbine 10 is anchored, is preferably more than 40 m, preferably even more than 50 m. The wind turbine 10 can also be held in a pre-discovered position in relation to the sea bed 42. The wind turbine 10 could even be anchored in water depths T greater than 100 m. The wind turbine 10 could also be anchored in water depths T greater than 100 m. The height H of the wind turbine 10 measured from the water surface 32 can be several 10 m. In principle, a wind turbine according to the invention can achieve a height H of 10 times greater than that of conventional floating offshore wind turbines, since the centre of gravity of the turbine 10 is particularly low and the flat-lying large ring generator 18 provides additional passive floating stability.

FIG. 2 shows a part of the wind turbine from FIG. 1 in perspective. In particular the rotor 12 with the rotor blades 13 is shown. The stator 20 and the rotor 22 of the generator 18 are also shown. The floating body 30 is not shown in FIG. 2. It can be seen that the rotor 12 has three rigid rotor blades 13, each located at a distance from the axis of rotation 14 of the shaft 16. This example shows a so-called H-rotor 12. Of course, a larger or smaller number of rotor blades 13 can also be provided. The rotor blades 13 have a straight span, i.e. the longitudinal axes 15 of the rotor blades 13 are straight and run parallel to each other and parallel to the axis of rotation 14. Furthermore, the rotor blades 13 have the same profile depth tₒ respective tᵤ at their upper and lower ends. Of course, other rotors 12 or rotor blades 13 can also be used within the scope of the invention, which will be explained in more detail below.

For example, FIG. 3 shows a wind turbine 10 with a different type of rotor 12. It can be clearly seen that the profile depth tₒ at the upper end of the rotor blades 13 is less than the profile depth tᵤ at the lower end. This takes account of the fact that the wind speeds immediately above the water surface 32 are lower than at greater heights H to the water surface 32. Due to the greater profile depth t at the lower end than at the upper end of the rotor blades 13, a largely constant lift distribution along the span of the rotor blades 13 acts despite different wind speeds at different heights H. In addition, the centre of gravity of the wind turbine 10 is shifted downwards by the greater masses at the lower ends of the rotor blades 13, which promotes the passive floating stability of the wind turbine 10 against tipping over. By geometrically twisting the rotor blades 13 around their longitudinal axes 15 (along the span), the local angle of attack of the rotor blades 13 can also be optimally adjusted. This ensures that the wind turbine 10 or the rotor 12 can operate even in stronger winds. This can also be used to vary the speed of the rotor 12. By optimally adjusting the local angle of attack, the speed of the rotor 12 can be kept largely constant, regardless of the wind force.

FIG. 4 shows another type of rotor 12 for the inventive wind turbine 10. It is a kind of Darrieus rotor 12 (so-called Twister). The rotor 12 has several rotor blades 13, each arranged at a distance from the rotation axis 14. The wingspans 15 of the rotor blades 13 are twisted around the axis of rotation 14 so that a helix shape results. Preferably the rotor blades 13 are each offset by a part of a circumference around the axis of rotation 14, which corresponds approximately to an inverse of the total number of rotor blades 13 of the rotor 12. In the example shown with three rotor blades 13, each of the rotor blades 13 thus extends from its lower end to its upper end over a range of about 120° (360° circumference/3 rotor blades).

If one combines rotor 12 from FIG. 3 with rotor 12 from FIG. 4, one gets a rotor 12, where on the one hand the profile depth tₒ at the upper end of the rotor blades 13 is less than the profile depth tᵤ at the lower end and on the other hand the longitudinal axes 15 of the rotor blades 13 are twisted around the axis of rotation 14. A section through an upper end of such designed rotor blades 13 in a view from above is shown as an example in FIG. 5. A corresponding section through a lower end of such rotor blades 13 is shown in FIG. 6.

Furthermore, FIGS. 7a and 7b show 10 wind turbines with a different type of rotor 12. Rotor 12 has several rotor blades 13, which have a conical shape relative to the axis of rotation 14. Such rotor blade inclinations can be used to regulate the torque through the action of the lever arm. In FIG. 7a, the distance between the rotor blades 13 and the rotation axis 14 at the lower end (aᵤ) of the rotor blades 13 is greater than at the upper end (aₒ). With respect to FIG. 7b, a distance between the rotor blades 13 and the axis of rotation 14 at the lower end (aᵤ) of the rotor blades 13 is smaller than at the upper end (aₒ), so that when wind is applied to the rotor blades 13 an upwardly directed force component FE acts on the rotor 12. FN is the normal component of the buoyancy force due to the application of wind to a rotor blade 13. The normal force FN is divided into a force component FR directed against the centrifugal force FZ and a component FE acting against gravity. In this way, the bearings for supporting the rotor 12 or the shaft 16, in particular the axial bearings 38, can be relieved. This makes it possible to use completely new bearings to support the rotor 12 in wind turbines, e.g. plain bearings, magnetic bearings (see FIG. 12) or even air bearings. In general, conically directed lift surfaces, pointed upwards or pointed downwards, can also contribute to the tuning of an optimum torque, which is made possible by an appropriate adaptation of the lever arms of the torque-generating wind forces on the rotor blade 13 along the span.

The large masses at the foot of the invention wind turbine 10 serve on the one hand to improve the passive floating stability due to the low centre of gravity and on the other hand to improve the moment of inertia of the rotor 12, so that it continues to rotate at an almost undiminished speed even in gusty wind, even if the wind drops briefly. This design also makes it possible to design the upper part of the wind turbine 10, in particular the rotor 12, in lightweight construction without impairing the synchronisation characteristics in gusty wind. This additionally promotes the floating stability of the wind turbine 10 without impairing the synchronization characteristics in gusty wind.

The ring generator 18 can have an energy generation section 80 with a generator stator 20 and a generator rotor 22 as well as a bearing section 82 which is designed to realize a magnetic bearing of the shaft 16 at least in one direction parallel to the vertical axis of rotation 14. The bearing section 82 preferably has a first circular or annular section 84 with magnets of a specific polarity and at least one second section 86 associated therewith with magnets of the same polarity, so that the two sections 84, 86 repel each other and at least one air gap 88 forms between the two sections 84, 86 when viewed in the vertical direction, so that the two sections 84, 86 are supported in the vertical direction without material contact solely by magnetic forces. For a wind turbine 10, the bearings after the rotor 12 and, if fitted, the gear module, are the most common cause of failure of the wind turbine 10. In the case of a rotor 12 with a vertical axis of rotation 14, the greatest inertial forces also act in the vertical direction (weight forces), since the centrifugal forces compensate each other. Due to the special design of the bearings 82 for absorbing the vertical forces as magnetic bearings, the availability of the wind turbine 10 can be decisively improved. The magnets can, for example, be superconducting magnets or controlled electromagnets. The magnetic bearing can be designed as a passive, active or electrodynamic magnetic bearing.

The transverse forces acting in the horizontal direction, mostly aerodynamic forces, can be absorbed by conventional mechanical bearings (ball bearings, plain bearings, roller bearings, etc.; see bearing 36). This is possible relatively easily, since the resulting transverse load on wind turbines 10 with a rotor 12 with a vertical axis of rotation 14 is small. In a further embodiment of the invention, however, it is also possible that the bearing section 82 is designed to realize a magnetic bearing of the shaft 16 also in a direction transverse to the vertical axis of rotation 14. An air gap 92 is formed in the horizontal direction between the 84 and 90 magnets with the same polarity. The magnets 84, 90 can also be designed as superconducting magnets or as regulated electromagnets. The magnetic bearing can be designed as a passive, active or electrodynamic magnetic bearing.

In order to reduce or completely avoid an undesired interaction between the magnetic fields for energy generation (in section 80) and the magnetic fields for the bearing arrangement (in section 82), it is suggested that the bearing section 82 of the ring generator 18 is offset and at a distance from the energy generation section 80 on the ring generator 18. In FIG. 12, the bearing portion 82 is formed on the ring generator 18 offset from the power generating portion 80 in the direction of the vertical axis of rotation 14. Alternatively or in addition, the bearing portion 82 may also be offset transversely to the vertical axis of rotation 14 from the power generating portion 80 on the ring generator 18. In order to achieve the safest and most reliable bearing possible, it is conceivable that several bearing sections 82 are formed on the ring generator 18. It is also conceivable to prefer at least one conventional mechanical bearing which assumes the bearing function in the event of failure of the magnetic bearing 82.

All previously described different types of rotors 12 or their respective features can be combined with each other as desired in order to obtain an optimum rotor 12 for the individual case.

FIG. 8 shows an example of a rotor blade 13 of a wind turbine 10 in which the rotor blade tip 13a is equipped with a winglet 19 in the upper area to increase the aerodynamic performance in order to minimize the edge vortex effects induced by the pressure compensation. A winglet 19 can be fitted on the tips 13a of all or only a few rotor blades 13 of a wind turbine 10. FIG. 9a shows an example of two rotor blades 13 of a wind turbine 10, where vortex generators 19a are arranged on the suction surface 13b of the rotor blades 13, directed towards the axis of rotation 14, near and along the trailing edge 13c of the blades 13. This prevents early flow separation at larger angles of attack along the wingspan. FIGS. 9b to 9d show details of the vortex generators 19a arranged side by side. These can have the following dimensions, for example: H=10 to 20 mm, L about 40 mm, S=30 to 50 mm, β=15° to 20° , and the distance Z=3×H to 5×H=30 to 100 mm.

FIG. 10 shows another example of an invented wind turbine 10. In addition to or as an alternative to the anchoring of the wind turbine 10 to the seabed 42, an arrangement can be provided by means of lines 40 which allows the wind turbine 10 to be positioned and aligned independently with respect to the seabed 42. The arrangement comprises a Global Navigation Satellite System (GNSS) 50, in order to be able to record a current position of the wind turbine 10 using satellite signals 52. The arrangement also includes a drive 54 to change the position and/or orientation of the wind turbine 10 on the water surface 32. In this example, the drive is designed as a propeller. This can be rotated about an axis of rotation 56 to change the direction of propulsion by the drive 54. Of course, the drive can also be designed differently, e.g. as a water jet drive variable in its direction. Finally, the arrangement also includes a control or regulating device 58 which is connected to the GNSS 50 and the drive 54 in order to control the drive 54 depending on the detected position of the wind turbine 10 in order to bring the wind turbine 10 into a desired position and/or alignment on the water surface 32. A rechargeable battery 60 may be provided to power the arrangement or its components 50, 54, 58. This could, for example, be charged by the electricity generated by the generator 18. Of course, the wind turbine 10 from FIG. 10 can also be combined with any of the rotors 12 described above and shown in FIGS. 1 to 9.

FIG. 11 shows an example of a wind farm 70 that is modularly constructed from several wind turbines 10 of the type described above. In the plan view, the floats 30 have such an outer circumferential shape that they can be arranged next to each other from several sides and attached to each other. In the example shown, the floats 30 have the shape of an even (isosceles and equiangular) octagon. Of course, floating bodies 30 can also have the shape of any other polygon. The dimensions of the floating body 30 in plan view are so large that the flat-lying large ring generator 18 and possibly other components of the wind turbines 10, e.g. frequency converters and/or control electronics, can be accommodated (e.g. length and width of the floating body 30 each 12 to 18 m). The floating bodies 30 of the individual wind turbines 10 are preferably rigidly connected to each other. In this case it would be sufficient if at least one of the wind turbines 10 is anchored to the seabed 42 via lines 40 or has an arrangement 50, 54, 58 for self-sufficient positioning and alignment of the wind turbine 10 with respect to the seabed 42. Separate floating modules of the same design may be attached to a floating body of one or more wind turbine(s) 10 and serve as both helicopter landing sites 30b and service ship docking stations 30c.

FIG. 13 shows part of another example of an inventive wind turbine 10. In the example, the rotor 12 has three rotor blades 13 attached at their undersides to a support structure of the rotor 12. Of course, a different number of rotor blades 13 per rotor 12 can also be provided. The rotor blades 13 have an asymmetrical, curved profile similar to that of an aircraft wing. The convex curved surfaces of the rotor blades 13 are directed inwards in the direction of the rotation axis 14. During commissioning or maintenance of the wind turbine 10, the radius of the rotor 12, i.e. the distance between the axis of rotation 14 of the rotor and a longitudinal axis 15 of the rotor blades 13 as well as an alignment of the rotor blades 13 around their respective longitudinal axis 15 can be manually adjusted. The shown rotor 12 is realized without wind tracking, since the alignment of the rotor blades 13 around their respective longitudinal axis 15 cannot be varied during the operation of the wind turbine. Winglets 19 are provided in the area of an upper end 13a of the rotor blades 13. It is also conceivable to arrange vortex generators (not shown) in the manner of the vortex generators 19a from FIG. 9b on the suction surface of the rotor blades 13 directed towards the axis of rotation 14, near and along the trailing edge 13c of the blades 13.

FIG. 14 shows part of another example of a wind turbine 10 according to the invention. In contrast to the example in FIG. 13, the rotor 12 shown here is equipped with an adjustable wind tracking system. The alignment of the rotor blades 13 around their respective longitudinal axis 15 can be varied during the operation of the wind turbine 10 (so-called pitch system). A permanent pitch control can be realized depending on wind direction and wind speed. This also makes it possible to set an optimum setting for wind load reduction when the rotor 12 is at a standstill. This rotor 12 can also be equipped with winglets 19 and/or vortex generators 19a, both of which are not shown here. In contrast to the rotor blades 13 in FIG. 13, these have a symmetrical profile in FIG. 14 and can therefore be manufactured at a particularly low cost.

The rotors 12 of wind turbines 10 shown in FIGS. 13 and 14 can also have a geometric twist of the rotor blades 13 around their longitudinal axes 15 (along the span).

FIG. 15 shows the bearing section 82 for the example in FIG. 14, which—as in the example in FIG. 12—is radially offset from the energy generation section 80 on the ring generator 18. Of course, other designs and arrangements of bearing section 82 and energy generation section 80 are also conceivable here. A motor 12a arranged in the rotor 12 can be seen very clearly, which can adjust a rotor blade 13 of the rotor 12 about the longitudinal axis 15 and thus the angle of attack of the blade 13 via a gear (not shown). It is recommended to provide a safety fence 30a on the floating body 30 at least in the area of the service flap 34, but preferably around the entire rotor 12, which prevents persons from entering the danger area of the rotor blades 13.

In summary, the invented wind turbine 10 may have one or more of the following characteristics:
A vertical axis rotor 12, preferably designed in lightweight construction.
Preferably two or three rotor blades 13 per rotor 12, evenly distributed over the circumference of the rotor 12 (in the case of two rotor blades 13 these have a distance of approximately 180° from each other in the circumferential direction, in the case of three rotor blades of approximately) 120°, whereby in principle more than three rotor blades 13 per rotor 12 can also be provided.
Geometry of blades 13: Darrieus type (rotor 12 with flexible, curved blades 13 of Canadian type), H-Darrieus type (rotor 12 with straight, rigid blades 13 according to FIGS. 1, 2 and 10), “twisted” rigid rotor blades 13 (3D strand design in double helix shape or preferably in triple helix shape according to FIG. 4).
Rotor blades 13 with increasing profile depth t along the span from the upper end (to) to the lower end (tu) of the blades 13 (to<tu), for optimal use of the wind flow due to the atmospheric boundary layer.
Rotor blades 13 are arranged on the circumferential surface of a cylinder (cf. FIGS. 1 to 6 and 10) or preferably of a cone (conical arrangement, cf. FIG. 7a, tapering to the top here, and FIG. 7b, tapering to the bottom here).
Mounted on floating platforms (floating body 30).
A generator 18 arranged inside the floating body 30, preferably in the form of a flat-lying large ring capacitor with an output of at least 7.5 MW.
At least one service flap 34 in the outer skin of the floating body 30 above the water surface 32.
The floating bodies 30 have a suitable shape which allows a modular construction of wind farms 70 from several wind turbines 10 attached to each other.
Between the rotor 12 of the wind turbine 10 and the generator 18 there is preferably no gear for converting the speed of the rotor 12 into another speed of the ring generator rotor 22; the generator rotor 22 rotates at the same speed as the rotor 12 of the wind turbine 10.
Bearing of the rotor shaft 16 in the floating body 30 by means of new bearing concepts, e.g. plain bearing, permanent magnet bearing, air bearing or a combination of such bearing concepts.
Drive arrangement with a GNSS 50, a drive 54 and a control or regulating device 58 for autonomous positioning and alignment of the wind turbine 10 with respect to the sea bed 42.

1. An offshore wind turbine floating on a water surface, the offshore wind turbine comprising:
a rotor having a shaft rotatable about a vertical axis of rotation, wherein
the rotor comprises several rotor blades, each of said several rotor blades having a substantially vertical span along a longitudinal axis and each being spaced from the rotational axis,
the shaft is connected with a generator which converts rotational movement of the shaft into electrical energy; and
at least one floating body, wherein
the generator is arranged in the floating body and is accessible via a service flap in the floating body from above the water surface, and
a profile depth (t) of the rotor blades at the lower end (tᵤ) of the rotor blades is greater than at the upper end (tₒ).

2. The Wind turbine according to claim 1, wherein
the generator is designed as a flat-lying ring generator which is directly connected to the shaft without interposition of a transmission and directly generates energy of a required mains frequency without interposition of a frequency converter.

3. The Wind turbine according to claim 2, wherein
the ring generator has an energy generating section with a generator stator and a generator rotor and a bearing section which is designed to implement a magnetic bearing of the shaft at least in one direction parallel to the vertical axis of rotation.

4. The Wind turbine according to claim 3, wherein
the bearing section is designed to implement a magnetic bearing of the shaft also in a direction transverse to the vertical axis of rotation.

5. The Wind turbine according to claim 4, wherein
the bearing section of the ring generator is formed on the ring generator offset in the direction of the vertical axis of rotation with respect to the energy generating section.

6. The Wind turbine according to claim 4, wherein
the bearing portion of the ring generator is formed on the ring generator transversely to the vertical axis of rotation offset from the power generating portion.

7. The Wind turbine according to claim 6, wherein
winglets are provided at the upper ends of the rotor blades.

8. The Wind turbine according to claim 7,
wherein on the suction surface of the rotor blades directed towards the axis of rotation and in the vicinity of and along a trailing edge vortex generators are arranged.

9. The Wind turbine according to claim 8, wherein
the rotor blades are each twisted about the axis of rotation by a part of a circumference which corresponds at least to the reciprocal of the total number of rotor blades of the rotor multiplied by 360°.

10. The Wind turbine according to claim wherein
the rotor comprises a plurality of rotor blades each having a span along a longitudinal axis and being arranged at a distance from the axis of rotation, a distance between the rotor blades and the axis of rotation at the lower end of the rotor blades being smaller than at the upper end, so that, when the rotor blades are acted upon by wind, an upwardly directed force component acts on the rotor or that a distance between the rotor blades and the axis of rotation at the lower end of the rotor blades is greater than at the upper end.

11. The Wind turbine according to claim 10, wherein
the rotor blades of the rotor are equipped with an adjustable wind tracking system, so that the alignment of the rotor blades about their respective longitudinal axis can he varied during operation of the wind turbine.

12. The Wind turbine according to claim 10, wherein
the wind turbine comprises a Global Navigation Satellite System (GNSS) for detecting a current position of the wind turbine, a drive for changing the position and/or orientation of the wind turbine on the water surface, and has a control or regulating device which is connected to the GNSS and the drive in order to control the drive as a function of the detected position of the wind turbine in order to bring the wind turbine into a desired position and/or alignment on the water surface.

13. The Wind turbine according to claim 12, further comprising:
a Global Navigation Satellite System (GNSS) for detecting a current position of the wind turbine,
a drive for changing the position and/or orientation of the wind turbine on the water surface, and
a control or regulating device which is connected to the GNSS and the drive in order to control the drive as a function of the detected position of the wind turbine in order to bring the wind turbine into a desired position and/or alignment on the water surface

14. An offshore wind farm comprising:
a plurality of offshore wind turbines, wherein the offshore wind farm is modularly constructed from a plurality of wind turbines according to claim 1.

15. The offshore wind farm according to claim 14, wherein
the wind turbines of the offshore wind farm are rigidly connected to one another.

16. The offshore wind farm according to claim 15, wherein
only at least one selected wind turbine of the wind farm comprises a GNSS for detecting a current position of the wind turbine and a drive for changing the position and/or orientation of the entire wind farm on the water surface.
